(19) United States
(12) Patent Application Publication
(10) Pub. No.: US 2026/0210482 A1
(43) Pub. Date: Jul. 23, 2026

(54) SINGLE PLANAR DUAL AXIS COMPACT POSITIONING MECHANISM

(71) Applicant: GE Precision Healthcare LLC, Waukesha, WI (US)

(72) Inventors: Vishwanath Nayak K, Bangalore (IN); Rengarajan K, Bangalore (IN); Saiesh Raiker, Bangalore (IN); Deepak Rajput, Bangalore (IN)

(21) Appl. No.: 19/033,394

(22) Filed: Jan. 21, 2025

(51) Int. Cl. F16M 11/04; B33Y 80/00; F16M 11/10

(52) U.S. Cl. CPC F16M 11/045; F16M 11/046; F16M 11/10; B33Y 80/00

(57) ABSTRACT

Various methods and systems are provided for a single planar dual axis positioning mechanism. For example, the positioning mechanism comprises a first lead screw, a second lead screw, a guide plate, a sliding block, and a frame. The sliding block comprises a first orifice to receive the first lead screw, a second orifice to receive the second lead screw, and a third orifice to receive the guide plate. The frame comprises a first cutout to receive the first lead screw, a second cutout to receive the second lead screw, and a first slot and a second slot to receive the guide plate. The sliding block is movable within a single plane along a first axis and/or a second axis that is perpendicular to the first axis in response to turning the first lead screw and/or the second lead screw and as guided by the guide plate.

### FIELD

Embodiments of the subject matter disclosed herein relate to moving an object in two dimensions using a single planar device.

### BACKGROUND

Dual axis (e.g., lateral-translational, horizontal-vertical, or X-Y axes) positioning mechanisms are configured to align, adjust, or position an object coupled thereto. Conventional dual axis positioning mechanisms may include two individual sliders that are arranged perpendicular and one over another in at least two different planes. The two sliders are dependent on each other to achieve desired motions along two axes. The conventional dual axis positioning mechanisms are thus bulky and complex.

### BRIEF DESCRIPTION

Various methods and systems are provided for a single planar dual axis compact positioning mechanism, also referred to herein as “the positioning mechanism”. The positioning mechanism may comprise a first lead screw, a second lead screw, a guide plate, a sliding block, and a frame. The sliding block may comprise a first orifice to receive the first lead screw, a second orifice to receive the second lead screw, and a third orifice to receive the guide plate. The frame may comprise a first cutout configured to receive the first lead screw, a second cutout configured to receive the second lead screw, and a first slot and a second slot configured to receive the guide plate, where the sliding block is movable within a single plane along a first axis and/or along a second axis that is perpendicular to the first axis in response to turning the first lead screw and/or the second lead screw and as guided by the guide plate.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, wherein below:

FIG. 1 shows a pictorial view of an exemplary imaging system;

FIG. 2 shows a block schematic diagram of the imaging system;

FIG. 3 shows a perspective view of a single plane, dual axis positioning mechanism;

FIG. 4 shows an exploded perspective view of the positioning mechanism;

FIG. 5 shows a top-down view of the positioning mechanism;

FIG. 6 shows a perspective view of the positioning mechanism with a sliding block having coupling extension receivers and a coupling extension;

FIG. 7 shows an exploded perspective view of the positioning mechanism with the coupling extension;

FIG. 8 shows a perspective view of the positioning mechanism coupled to a system;

FIG. 9 shows a perspective view of the positioning mechanism where the sliding block includes a tilt mechanism receiver and a tilt mechanism;

FIG. 10 shows an exploded perspective view of the positioning mechanism with the tilt mechanism;

FIG. 11 shows perspective views of a tilt plate and a coupling plate that may be coupled to the positioning mechanism;

FIG. 12 shows a perspective view of the positioning mechanism with the tilt plate and the coupling plate coupled thereto;

FIG. 13 shows a perspective view of the positioning mechanism with the tilt plate and the coupling plate coupled thereto;

FIG. 14 shows a side view of the positioning mechanism with the tilt plate coupled thereto and in a neutral configuration;

FIG. 15 shows a side view of the positioning mechanism with the tilt plate coupled thereto and in a tilted configuration;

FIG. 16 shows a perspective view of the positioning mechanism with a phantom coupled to the tilt plate;

FIG. 17 shows a side view of the positioning mechanism with the coupling plate and the tilt plate coupled thereto;

FIG. 18 shows a top-down view of the positioning mechanism with the coupling plate and the tilt plate coupled thereto; and

FIG. 19 shows a flowchart of a method for a single plane dual axis positioning mechanism.

### DETAILED DESCRIPTION

The following description relates to various embodiments of a single plane, dual axis positioning mechanism. The single plane, dual axis positioning mechanism, herein “the positioning mechanism” comprises a single plane slider frame, a sliding block, a first lead screw and a second lead screw each having a knob at a first end, and a two-way guide plate. The positioning mechanism further includes polymer-based bush bearings and liners between moving parts.

The positioning mechanism is configured to achieve two independent motions (e.g., lateral-translational or horizontal-vertical) through a single plane frame and two-way slider design. Dual axis movement is integrated in the single plane frame using a rotational sliding joint design. Turning the first lead screw (e.g., clockwise or counter-clockwise) moves the sliding block along a first axis (e.g., a translational axis, the x-axis), and further causes the second lead screw to slide and hold a position of the sliding block along a second axis (e.g., a lateral axis, the y-axis), perpendicular to the first axis. Turning the second lead screw moves the sliding block along the second axis and further causes the first lead screw to slide and hold the position of the sliding block along the first axis. Both x-axis and y-axis movements are thus achieved in the single sliding block. Likewise, x-axis and y-axis movements are achieved in a single plane, thus the positioning mechanism eliminates demand for two linear sliders and/or multiple blocks to achieve the dual axis movement.

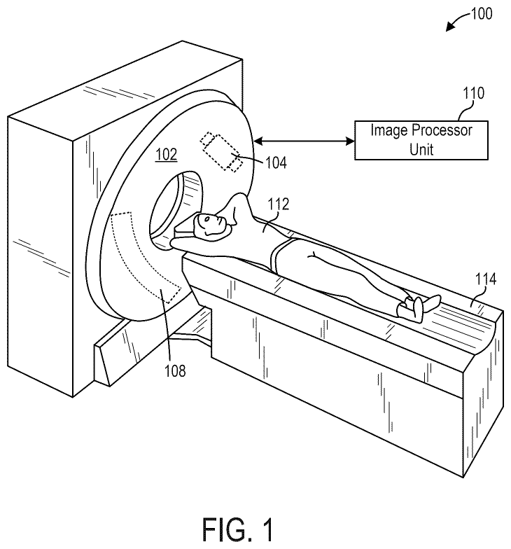

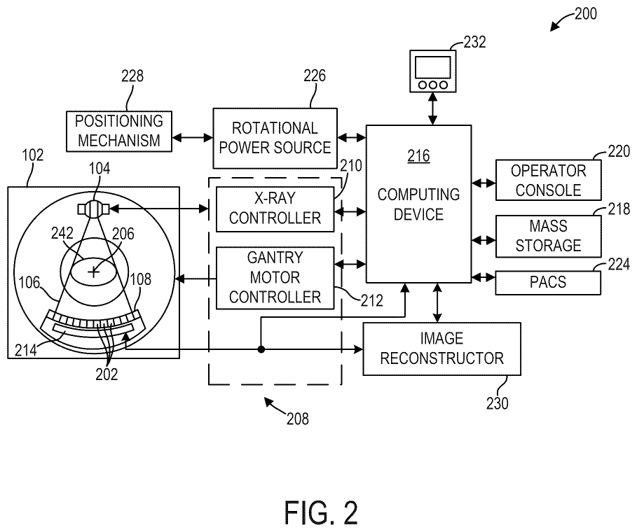

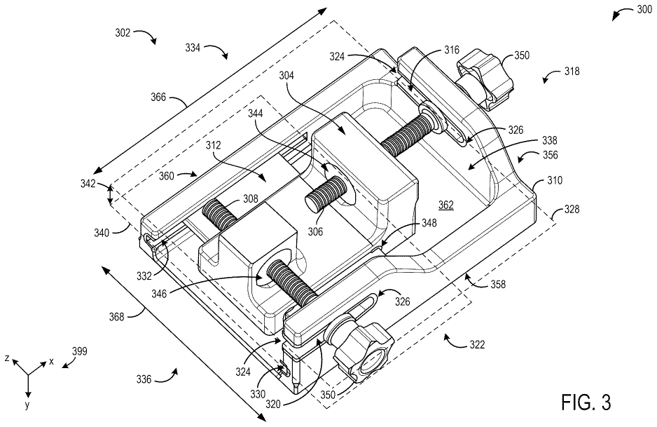

The systems and methods herein disclosed will now be described, by way of example, with respect to the figures, wherein FIGS. 1 and 2 show an exemplary imaging system, FIGS. 3-16 show various configurations of a single plane, dual axis positioning mechanism.

FIG. 1 illustrates an exemplary imaging system 100. The imaging system 100 may be an example of a computed tomography (CT) system that is configured to image a subject 112 such as a patient, an inanimate object, one or more manufactured parts, and/or foreign objects such as dental implants, stents, and/or contrast agents present within the body or subject placed on a table 114. The table 114 may be motorized and may be selectively moveable. In one embodiment, the imaging system 100 includes a gantry 102, which in turn, may further include at least one X-ray radiation source 104 configured to project an X-ray beam for use in imaging the subject 112. The X-ray radiation source 104 includes an X-ray tube and a target. The X-ray tube generates X-rays by accelerating and focusing a high-energy beam of electrons onto a rotating target. As individual electrons strike the target, the energy released by interacting with the atoms of the target produces X-ray photons isotropically under a polychromatic spectrum, a maximum energy of the X-ray photons matching that of the incident electrons. The X-ray photons leave the tube through a window that defines an X-ray beam. The beam can then be collimated and conditioned using collimator blades and filter(s).

Specifically, the X-ray radiation source 104 is configured to project the X-ray beam towards a detector array 108 positioned on the opposite side of the gantry 102. Although FIG. 1 depicts a single X-ray radiation source 104, in certain embodiments, multiple radiation sources may be employed to project a plurality of X-ray beams for acquiring projection data corresponding to the subject 112 at different energy levels. The radiation source may include an X-ray target manufactured of graphite and metal.

In certain embodiments, the imaging system 100 further includes an image processing unit 110 configured to reconstruct images of a target volume of the subject 112 using an iterative or analytic image reconstruction method. For example, the image processing unit 110 may use an analytic image reconstruction approach such as filtered back projection (FBP) to reconstruct images of a target volume of the subject 112. As another example, the image processing unit 110 may use an iterative image reconstruction approach such as advanced statistical iterative reconstruction (ASIR), conjugate gradient (CG), maximum likelihood expectation maximization (MLEM), model-based iterative reconstruction (MBIR), and so on to reconstruct images of a target volume of the subject 112.

FIG. 2 illustrates an exemplary imaging system 200 similar to the imaging system 100 of FIG. 1. The imaging system 200 includes at least some of the elements of the imaging system 100. In one embodiment, the system 200 includes the detector array 108. The detector array 108 further includes a plurality of detector elements 202 that together sense an X-ray beam 106 that pass from the X-ray radiation source 104 to the detector array 108 through the subject 112 to acquire corresponding projection data. Accordingly, in one embodiment, the detector array 108 is fabricated in a multi-slice configuration including the plurality of rows of cells or detector elements 202. In such a configuration, one or more additional rows of the detector elements 202 are arranged in a parallel configuration for acquiring the projection data.

In certain embodiments, the system 200 is configured to traverse different angular positions around the subject 112 for acquiring desired projection data. Accordingly, the gantry 102 and the components mounted thereon (such as the radiation source 104, the housing 242, and the detector array 108) may be configured to rotate about a center of rotation 206 for acquiring the projection data, for example, at different energy levels. Alternatively, in embodiments where a projection angle relative to the subject 112 varies as a function of time, the mounted components may be configured to move along a general curve rather than along a segment of a circle.

In one embodiment, the system 200 includes a control mechanism 208 to control movement of the components such as rotation of the gantry 102 and the operation of the X-ray radiation source 104. In certain embodiments, the control mechanism 208 further includes an X-ray controller 210 configured to provide power and timing signals to the radiation source 104. Additionally, the control mechanism 208 includes a gantry motor controller 212 configured to control a rotational speed and/or position of the gantry 102 based on imaging requirements.

In certain embodiments, the control mechanism 208 further includes a data acquisition system (DAS) 214 configured to sample analog data received from the detector elements 202 and convert the analog data to digital signals for subsequent processing. The data sampled and digitized by the DAS 214 is transmitted to a computing device (also referred to as processor) 216. In one example, the computing device 216 stores the data in a storage device 218. The storage device 218, for example, may include a hard disk drive, a floppy disk drive, a compact disk-read/write (CD-R/W) drive, a Digital Versatile Disc (DVD) drive, a flash drive, and/or a solid-state storage device.

Additionally, the computing device 216 provides commands and parameters to one or more of the DAS 214, the X-ray controller 210, and the gantry motor controller 212 for controlling system operations such as data acquisition and/or processing. In certain embodiments, the computing device 216 controls system operations based on operator input. The computing device 216 receives the operator input, for example, including commands and/or scanning parameters via an operator console 220 operatively coupled to the computing device 216. The operator console 220 may include a keyboard or a touchscreen to allow the operator to specify the commands and/or scanning parameters.

Although FIG. 2 illustrates one operator console 220, more than one operator console may be coupled to the system 200, for example, for inputting or outputting system parameters, requesting examinations, and/or viewing images. Further, in certain embodiments, the system 200 may be coupled to multiple displays, printers, workstations, and/or similar devices located either locally or remotely, for example, within an institution or hospital, or in an entirely different location via one or more configurable wired and/or wireless networks such as the Internet and/or virtual private networks.

In one embodiment, for example, the system 200 either includes, or is coupled to a picture archiving and communications system (PACS) 224. In an exemplary implementation, the PACS 224 is further coupled to a remote system such as a radiology department information system, hospital information system, and/or to an internal or external network (not shown) to allow operators at different locations to supply commands and parameters and/or gain access to the image data.

The computing device 216 uses the operator-supplied and/or system-defined commands and parameters to operate a rotational power source 226, which in turn, may control a positioning mechanism 228. For example, the positioning mechanism 228 may be a single plane, dual axis positioning mechanism that is configured to move a sliding block thereof within a single plane along a first axis and/or a second axis that is perpendicular to the first axis in response to turning a first lead screw and/or a second lead screw of the positioning mechanism 228 in a clockwise and/or counter-clockwise direction. The first lead screw and/or the second lead screw may be independently turned by the rotational power source 226. The computing device 216 may actuate the rotational power source 226 to turn the first lead screw, the second lead screw, and in some examples a third lead screw for appropriately positioning elements coupled to the positioning mechanism 228, such as in the gantry 102 for acquiring projection data corresponding to a target phantom coupled to the positioning mechanism 228. Further detail regarding the positioning mechanism and adjustment thereof is described with respect to FIGS. 3-19.

As previously noted, the DAS 214 samples and digitizes the projection data acquired by the detector elements 202. Subsequently, an image reconstructor 230 uses the sampled and digitized X-ray data to perform high-speed reconstruction. Although FIG. 2 illustrates the image reconstructor 230 as a separate entity, in certain embodiments, the image reconstructor 230 may form part of the computing device 216. Alternatively, the image reconstructor 230 may be absent from the system 200 and instead the computing device 216 may perform one or more functions of the image reconstructor 230. Moreover, the image reconstructor 230 may be located locally or remotely, and the image reconstructor 230 may be operatively connected to the system 100 using a wired or wireless network. Particularly, one exemplary embodiment may use computing resources in a “cloud” network cluster for the image reconstructor 230.

In one embodiment, the image reconstructor 230 stores the images reconstructed in the storage device 218. Alternatively, the image reconstructor 230 transmits the reconstructed images to the computing device 216 for generating useful patient information for diagnosis and evaluation. In certain embodiments, the computing device 216 transmits the reconstructed images and/or the patient information to a display 232 communicatively coupled to the computing device 216 and/or the image reconstructor 230.

FIG. 3 shows a perspective view 300 of a single plane, dual axis positioning mechanism 302. The positioning mechanism 302 may be an example of the positioning mechanism 228 of FIG. 2 that is used to adjust a position of an element coupled to the positioning mechanism 228 via a single plane element (e.g., a sliding block). A set of reference axes are provided in FIGS. 3-20. for comparison of the orientations shown therein. The reference axes 399 include an x-axis, a y-axis, and a z-axis. The x-axis may be parallel with an axial direction, and the y- and z-axes may be parallel with radial directions. Other orientations of the reference axes are possible. A filled dot may represent the corresponding axis pointing out of the page, and an unfilled dot may represent the corresponding axis pointing into the page.

The positioning mechanism 302 includes a first lead screw 306, a second lead screw 308, a two-way guide plate (e.g., “the guide plate”) 312, a sliding block 304, and a single-plane slider frame (e.g., “the frame”) 310. One or more of the guide plate 312, the sliding block 304, and the frame 310 may be formed via additive manufacturing, such as metal based 3D printing or polymer based 3D printing. In alternate examples, one or more of the guide plate 312, the sliding block 304, and the frame 310 may be formed via conventional manufacturing.

The frame 310 comprises a first wall 356 at a first end 318, a second wall 358 at a first side 322 that is perpendicular to the first end 318, a third wall 360 at a second side 334 that is parallel to the first side 322, and a base 362. The frame 310 may not have a wall on a second end 336. Further, the frame 310 may not have a surface that extends parallel to the base 362 that encloses the sliding block 304. The first wall 356, the second wall 358, the third wall 360, and the base 362 thus form a cavity 338 that is open on two sides (e.g., a top, parallel and opposite the base 362, and the second end 336).

The frame 310 has a first cutout 316 in the first wall 356 and a second cutout 320 in the second wall 358. The first cutout 316 may be configured to receive the first lead screw 306. The second cutout 320 may be configured to receive the second lead screw 308. Each of the first cutout 316 and the second cutout 320 may have an open side 324 and a closed side 326. In other examples, either or both of the first cutout 316 and the second cutout 320 may have two closed sides. The first cutout 316 and the second cutout 320 are coplanar in a first plane 328 (e.g., parallel to the z-x plane).

The frame 310 further comprises a first slot 330 on the second wall 358, and a second slot 332 on the third wall 360. Each of the first slot 330 and the second slot 332 may have a rectangular prism shape with four closed sides and two open sides, where the two open sides face and open the respective slot towards the second end 336 of the positioning mechanism 302 and towards the cavity 338 of the frame 310. The first slot 330 and the second slot 332 are coplanar in a second plane 340. The second plane 340 is vertically below the first plane 328, as illustrated by double arrow 342. The first slot 330 and the second slot 332 may be configured to receive the guide plate 312.

The sliding block 304 is positioned in the cavity 338 of the frame 310 between the first wall 356, the second wall 358, and the third wall 360. The sliding block 304 comprises a first orifice 344 configured to receive the first lead screw 306, a second orifice 346 configured to receive the second lead screw 308, and a third orifice 348 configured to receive the guide plate 312. Each of the first orifice 344, the second orifice 346, and the third orifice 348 extend through widths of the sliding block 304 such that elements inserted into each orifice may pass through the respect orifice from a first side to a second side. The sliding block 304 is positioned such that the first orifice 344 of the sliding block 304 is parallel to the first cutout 316 of the frame 310, and the second orifice 346 of the sliding block 304 is parallel to the second cutout 320 of the frame 310. The third orifice 348 of the sliding block 304 is parallel to the first slot 330 and the second slot 332 of the frame 310.

The guide plate 312 is positioned in the positioning mechanism 302 in such a way that enables single plane, dual axis motion of the sliding block 304 in response to adjustment of the first lead screw 306 and/or the second lead screw 308. The guide plate 312 is positioned in the third orifice 348 of the sliding block 304 and extends outside of the third orifice 348 on the first side 322 and the second side 334. On the first side 322, the guide plate 312 extends into the first slot 330 of the frame 310. On the second side 334, the guide plate 312 extends into the second slot 332 of the frame 310.

The first lead screw 306 is positioned in the first orifice 344 of the sliding block 304 and the first cutout 316 of the frame 310, such that the first lead screw 306 extends from the first end 318 of the positioning mechanism 302 towards the second end 336 of the positioning mechanism 302. The second lead screw 308 is positioned in the second orifice 346 of the sliding block 304 and the second cutout 320 of the frame 310, such that the second lead screw 308 extends from the first side 322 of the positioning mechanism 302 towards the second side 334 of the positioning mechanism 302. Thus, the first lead screw 306 is perpendicular to the second lead screw 308. The first lead screw 306 and the second lead screw 308 may be formed of a rigid material, such as a plastic and/or metal, such that the first lead screw 306 and the second lead screw 308 are positioned in the first plane 328 (e.g., the same plane as the first cutout 316 and the second cutout 320).

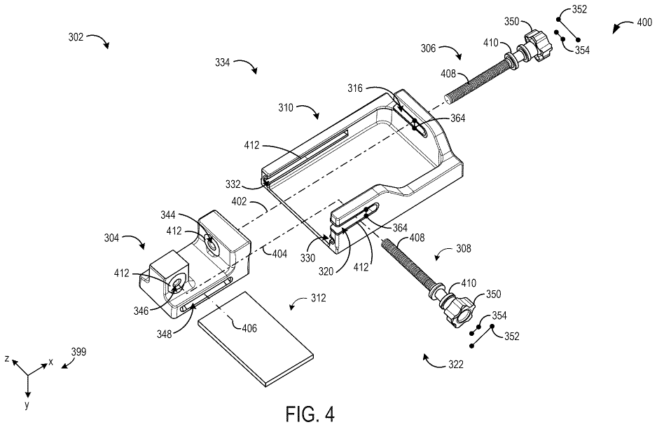

FIG. 4 shows an exploded perspective view 400 of the positioning mechanism 302 of FIG. 3. Dashed lines illustrate assembly of the positioning mechanism 302. For example, a first dashed line 402 illustrates positioning of the first lead screw 306 with respect to the first cutout 316 of the frame 310 and the first orifice 344 of the sliding block 304. Described another way, the first dashed line 402 may be coaxial with an axis that the first lead screw 306 is centered around. When the positioning mechanism 302 is assembled, the first lead screw 306 may extend through the first cutout 316. The first orifice 344 and the first cutout 316 may be coaxial. The first lead screw 306 may extend at least partially through and be coupled to the sliding block 304 via the first orifice 344 when the positioning mechanism 302 is assembled. The first lead screw 306 may include threading that mates with threading of the first orifice 344 of the sliding block 304. A second dashed line 404 illustrates positioning of the second lead screw 308 with respect to the second cutout 320 of the frame 310 and the second orifice 346 of the sliding block 304. Described another way, the second dashed line 404 may be coaxial with an axis that the second lead screw 308 is centered around. When the positioning mechanism 302 is assembled, the second lead screw 308 may extend through the second cutout 320. The second orifice 346 and the second cutout 320 may be coaxial. The second lead screw 308 may extend at least partially through and be coupled to the sliding block 304 via the second orifice 346 when the positioning mechanism 302 is assembled. The second lead screw 308 may include threading that mates with threading of the second orifice 346 of the sliding block 304.

A third dashed line 406 illustrates positioning of the guide plate 312 with respect to the third orifice 348 of the sliding block 304. The guide plate 312 may slide into the third orifice 348 along the third dashed line 406. Further, the guide plate 312 may extend through the sliding block 304 on both the first side 322 and the second side 334 such that the guide plate 312 extends into the first slot 330 and the second slot 332.

The first lead screw 306 and the second lead screw 308 may include a body 408, a slide bearing 410, and a knob 350. The body 408 may be coupled to the knob 350 via the slide bearing 410 such that the body 408, the knob 350, and the slide bearing 410 move as a single unit (e.g., as the first lead screw 306, the second lead screw 308). The body 408 may include a threading that is complementary to a threading of each of the first orifice 344 and the second orifice 346.

The positioning mechanism 302 may include polymer-based bush bearings and/or liners 412 positioned in one or more of the first orifice 344 of the sliding block 304, the second orifice 346 of the sliding block 304, and the third orifice 348 of the sliding block 304. The polymer-based bush bearings and/or liners 412 of the first orifice 344 and/or the second orifice 346 may include a threading that is complementary to the threading of the first lead screw 306 and the second lead screw 308, respectively. The positioning mechanism 302 may further include polymer-based bush bearings and/or liners 412 positioned in one or more of the first cutout 316 of the frame 310, the second cutout 320 of the frame 310, the first slot 330 of the frame 310, and the second slot 332 of the frame 310.

The slide bearing 410 may include a smooth (e.g., non-threaded) surface that is coaxial with the body 408 and the knob 350. The smooth surface enables sliding of the respective lead screw along the respective cutout of the frame 310 without rotating the respective lead screw. When the positioning mechanism 302 is assembled, the slide bearing 410 of the first lead screw 306 may be positioned in the first cutout 316, and the slide bearing 410 of the second lead screw 308 may be positioned in the second cutout 320. As further described herein, turning one of the first lead screw 306 and the second lead screw 308 (e.g., via the knob 350) may cause the sliding block 304 to move in a corresponding direction along an axis that is coaxial with the lead screw being turned. The other lead screw of the first lead screw 306 and the second lead screw 308 that is not being turned may slide along the respective cutout of the frame 310 along an axis parallel to the axis of the lead screw being turned. For example, the first lead screw 306 may be turned in a first rotational direction to move the sliding block 304 along a first axis that is parallel to the x-axis, with respect to the reference axes 399. As the sliding block 304 slides along the first axis, the second lead screw 308, which is coupled to the sliding block 304 at the second orifice 346, slides within the second cutout 320 in a direction that is parallel to the first axis (e.g., parallel to the x-axis). The smooth surface of the slide bearing 410 of the second lead screw 308 enables the second lead screw 308 to slide within the second cutout 320 without turning the second lead screw 308, and thus without moving the sliding block 304 in a direction parallel to the axis of the second lead screw 308 (e.g., parallel to the z-axis).

A knob diameter 352 of the knob 350 is greater than a screw diameter 354 of each of the first lead screw 306 and the second lead screw 308. Further, the knob diameter 352 may be greater than a cutout height 364 of the first cutout 316 and the second cutout 320. The first lead screw 306 and the second lead screw 308 may thus be prevented from passing through the first cutout 316 and the second cutout 320, respectively, and into the cavity 338 of the frame 310 such that an entirety of each of the first lead screw 306 and/or the second lead screw 308 is in the cavity 338 of the frame 310.

Returning to FIG. 3, arrows are shown illustrating single plane dual axis movement of the positioning mechanism 302. The sliding block 304 is movable within a single plane that is parallel to the first plane 328 and the second plane 340. Within the single plane, the sliding block 304 may be moved along a first axis 366 (e.g., translational, vertical, or x-axis) and/or along a second axis 368 (e.g., lateral, horizontal, or z-axis) that is perpendicular to the first axis in response to turning the first lead screw 306 and/or the second lead screw 308 and as guided by the guide plate 312. Turning the first lead screw 306 moves the sliding block 304 along the first axis 366. For example, the first lead screw 306 may be turned in a first rotational direction (e.g., clockwise) to move the sliding block 304 towards the first end 318 of the frame 310, and may be turned in a second rotational direction, opposite the first rotational direction (e.g., counter-clockwise) to move the sliding block 304 towards the second end 336 of the frame 310. Turning the second lead screw 308 moves the sliding block 304 along the second axis 368. For example, the second lead screw 308 may be turned in a first rotational direction (e.g., clockwise) to move the sliding block 304 towards the first side 322 of the frame 310, and may be turned in a second rotational direction, opposite the first rotational direction (e.g., counter-clockwise) to move the sliding block 304 towards the second side 334 of the frame 310.

The first lead screw 306 and the second lead screw 308 function as rotational sliding joints. Turning the first lead screw 306 further causes the second lead screw 308 to slide along the first axis 366 (e.g., as a single unit with the sliding block 304) and hold a position of the sliding block 304 along the second axis 368. Turning the second lead screw 308 further causes the first lead screw 306 to slide along the second axis 368 (e.g., as a single unit with the sliding block 304) and hold a position of the sliding block 304 along the first axis 366. Movement along both the first axis 366 and the second axis 368 of a single plane are thus achieved using the single sliding block 304 of the positioning mechanism 302. Movements along each of the first axis 366 and the second axis 368 may be achieved independently and without use of additional parts (e.g., additional sliding blocks) to achieve secondary motion (e.g., movements along both of the first axis 366 and the second axis 368). The positioning mechanism 302 therefore eliminates demand for two linear sliders and/or multiple blocks to achieve the dual axis movement. Movement of the sliding block 304 along the first axis 366 and along the second axis 368, and related movement of the first lead screw 306 and the second lead screw 308 in motion, as the sliding block 304, the first lead screw 306, and the second lead screw 308 do not act as a frame or fixed support structure. The sliding block 304, the guide plate 312, the first lead screw 306, and the second lead screw 308 are housed in the frame 310 such that, when the frame 310 is fixed and/or stationary (e.g., the frame 310 is fixed to a system), the sliding block 304 and one or both of the first lead screw 306 and the second lead screw 308 move with respect to the frame 310. Unlike conventional positioning mechanisms, the frame 310 may not contribute to motion.

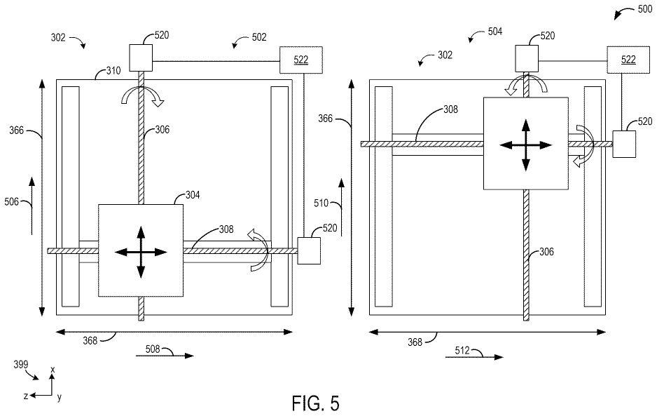

FIG. 5 shows a top-down view 500 of the single plane, dual axis positioning mechanism 302 of FIGS. 3-4. The top-down view 500 shows the positioning mechanism 302 as a simplified block diagram. The positioning mechanism 302 enables x-y motion in the same plane via a single (e.g., one) moving member. As briefly described with respect to FIG. 3, the frame 310 of the positioning mechanism 302 may be fixed to a system such that the frame 310 is stationary and the sliding block 304 moves with respect to the frame 310 in response to turning the first lead screw 306 and/or the second lead screw 308 in a clockwise and/or counter-clockwise direction.

A first configuration 502 of the positioning mechanism 302 shows the sliding block 304 in a first position (e.g., a lower left corner of the frame 310). A second configuration 504 of the positioning mechanism 302 shows the sliding block 304 in a second position that is different from the first position (e.g., an upper right corner of the frame 310). Movement of the sliding block 304 from the first position to the second position may be achieved by turning both of the first lead screw 306 and the second lead screw 308. For example, the first lead screw 306 may be turned clockwise to move the sliding block 304 in a first direction 506 along the first axis 366. The second lead screw 308 may be turned clockwise to move the sliding block 304 in a second direction 508 along the second axis 368.

Similarly, movement of the sliding block 304 from the second position (e.g., of the second configuration 504) to the first position (e.g., of the first configuration 502) may be achieved by turning both of the first lead screw 306 and the second lead screw 308. For example, the first lead screw 306 may be turned counter-clockwise to move the sliding block 304 in a third direction 510 along the first axis 366. The second lead screw 308 may be turned counter-clockwise to move the sliding block 304 in a fourth direction 512 along the second axis 368.

The first lead screw 306 and the second lead screw 308 may be turned at the same time or independently. For example, a position of the sliding block 304 along the first axis 366 may be adjusted first, followed by adjustment of the position of the sliding block 304 along the second axis 368, or vice-versa. Alternatively, the position of the sliding block 304 along the first axis 366 and along the second axis 368 may be adjusted at the same time by turning of the first lead screw 306 and the second lead screw 308. The position of the sliding block 304 along the first axis 366 may thus be adjusted independently of the position of the sliding block 304 along the second axis 368. Described another way, the sliding block 304 may be moved towards the first end 318 or towards the second end 336 of the frame 310 by turning the first lead screw 306 independent of and/or at the same time as the second lead screw 308 is turned to move the sliding block 304 towards the first side 322 or towards the second side 334 of the frame 310.

In some examples, a position of the sliding block 304 may be adjusted by manual adjustment of the first lead screw 306 and/or the second lead screw 308. In other examples, a position of the sliding block 304 may be automatically adjusted using one or more rotational power sources. For example, the first lead screw 306 and/or the second lead screw 308 may be coupled to a rotational power source 520 configured to selectively apply rotational power to the first lead screw 306 and/or the second lead screw 308. The rotational power source 520 may be a motor that is operated and/or powered with a pneumatic, hydraulic, and/or electric based system. Each of the first lead screw 306 and the second lead screw 308 may be coupled to a single, independent rotational power source 520 that are both coupled to a joint control system 522. Alternatively, the first lead screw 306 and the second lead screw 308 may be coupled to the same rotational power source 520. The rotational power source(s) 520 may be controlled by a controller of a system. For example, the rotational power source(s) 520 may be an example of the rotational power source 226 of FIG. 2 and may be communicably coupled to the computing device 216. The computing device 216 may store instructions in a memory thereof and may automatically (e.g., in response to receiving user input, in response to detection of an element coupled to the positioning mechanism 302) direct the rotational power source(s) 520 to supply rotational power to the first lead screw 306 and/or to the second lead screw 308 to turn a respective lead screw(s) and adjust a position of the sliding block 304 in the single plane.

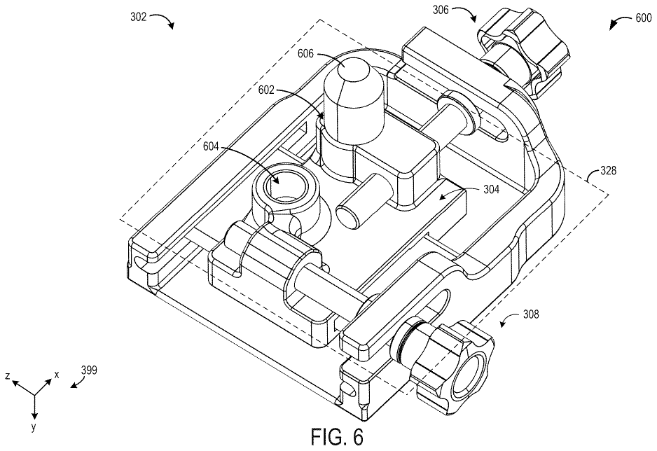

FIG. 6 shows a second perspective view 600 of the single plane, dual axis positioning mechanism 302 of FIGS. 3-5. In FIG. 6, the sliding block 304 of the positioning mechanism 302 includes a first coupling extension receiver 602 and a second coupling extension receiver 604. A coupling extension 606 may be inserted into and/or otherwise fixedly or selectively coupled to the sliding block 304 at the first coupling extension receiver 602 and/or the second coupling extension receiver 604. The coupling extension 606 may extend from the sliding block 304 perpendicular to the single plane in which the sliding block 304 is moveable. The coupling extension 606 may further extend from the sliding block 304 perpendicular to the first plane 328 (e.g., parallel to the y-axis). The positioning mechanism 302 may be coupled to a component at the coupling extension 606, such as a phantom, an imaging system, and/or another component for which single plane, dual axis positioning is desired.

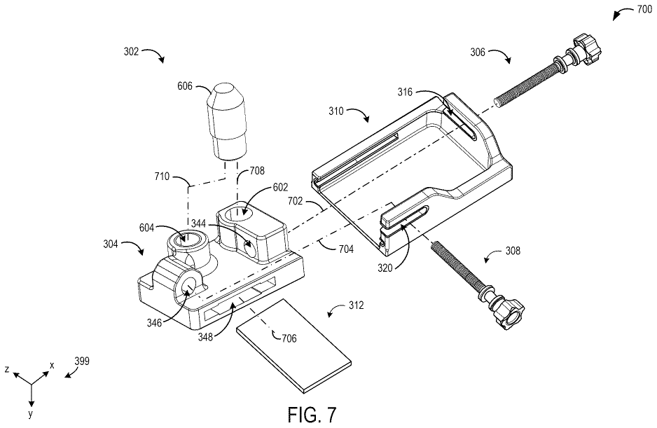

FIG. 7 shows an exploded perspective view 700 of the positioning mechanism 302 of FIGS. 3-6, including the coupling extension 606 and the sliding block 304 having the first coupling extension receiver 602 and the second coupling extension receiver 604. Dashed lines illustrate axes for positioning of the first lead screw 306, the second lead screw 308, the coupling extension 606, and the sliding block 304 when the positioning mechanism 302 is assembled. For example, a first dashed line 702 illustrates positioning of the first lead screw 306 with respect to the first cutout 316 of the frame 310 and the first orifice 344 of the sliding block 304. Described another way, the first lead screw 306 may be coaxial with the first orifice 344. A second dashed line 704 illustrates positioning of the second lead screw 308 with respect to the second cutout 320 of the frame 310 and the second orifice 346 of the sliding block 304. Described another way, the second lead screw 308 may be coaxial with the second orifice 346. A third dashed line 706 illustrates positioning of the guide plate 312 with respect to the third orifice 348 of the sliding block 304. Described another way, the guide plate 312 is coaxial with the third orifice 348. A fourth dashed line 708 and a fifth dashed line 710 illustrate positioning of the coupling extension 606 in the first coupling extension receiver 602 or the second coupling extension receiver 604, respectively. Described another way, the coupling extension 606 may be coaxial with the first coupling extension receiver 602 and/or the second coupling extension receiver 604. In some examples, the positioning mechanism 302 may include two coupling extensions, where one or more of the two coupling extensions are configured as the coupling extension 606, and a single coupling extension is positioned in each of the first coupling extension receiver 602 and the second coupling extension receiver 604.

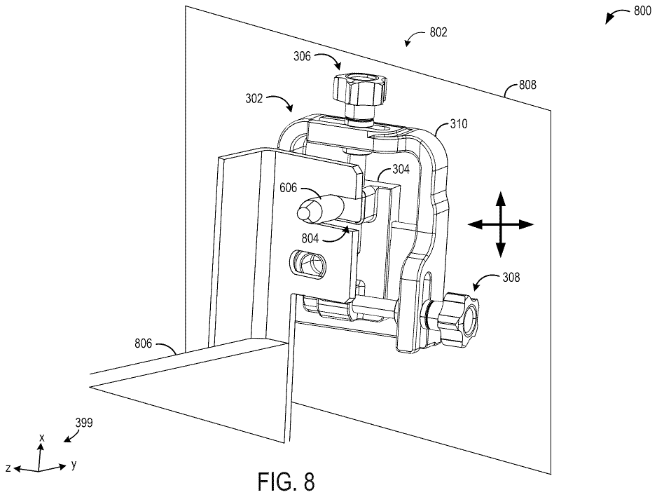

Turning to FIG. 8, a perspective view 800 is shown including an example of the positioning mechanism 302 coupled to a system 802. The system 802 may be an imaging system, such as a computed tomography imaging system (e.g., the imaging system 100, 200 of FIGS. 1-2). The positioning mechanism 302 may be coupled to the system 802 at the coupling extension 606 and at the frame 310. For example, the coupling extension 606 may slide into a cutout 804 of the system 802, such as on an arm 806 of the system 802. In other examples, the positioning mechanism 302 may be coupled to the system 802 at the coupling extension 606 via a clamp, a fastener, and/or another type or selective and/or fixed coupling device of the system 802 attached to the coupling extension 606. The frame 310 may be coupled to another part of the system 802 that is moveably separate from the part of the system 802 that the coupling extension 606 is coupled to (e.g., the arm 806). For example, the frame 310 may be coupled to a CT gantry cover 808 that is moveable independent of the arm 806. In other examples, the frame 310 may be coupled to another system and/or device that is separate from the system 802. In the example of FIG. 8, the frame 310 may be coupled to the CT gantry cover 808 via one or more selective and/or fixed coupling devices, such as screws, welds, clamps, and so on, such that the CT gantry cover 808 is configured to move in response to movement of the frame 310.

The CT gantry cover 808 may be an aesthetic enclosure positioned around a CT gantry. The positioning mechanism 302 may support one or more CT gantry covers 808 that may encase the entire gantry, preventing an imaging subject from accessing moving parts of the gantry. Typically, covers are comprised of six interconnected sub-components: the front, rear, two sides, and two top sections, that together form a protective envelope around the gantry. A design of the covers includes a hollow protrusion at the center, allowing the imaging subject to enter the gantry. The protrusion is concentric with a rotating envelope of the gantry, and is designed with precise clearances. Rear cover mechanism brackets ensure proper alignment of the cover with the gantry, facilitating the intended functionality. Conventional designs for a positioning mechanism for the rear cover include sheet metal and machined parts that numbers to multiple parts for planar movement in two directions. With multiple parts, the existing mechanism does not offer uniform or effortless movement. Further, this restricts alignment with the cover mounted on the gantry. The positioning mechanism 302 described herein enables a broader range of motion for the CT gantry over 808.

As described with respect to FIGS. 3-7, the sliding block 304 is configured to move independent of the frame 310. In the example of FIG. 8, the arm 806 and thus the sliding block 304 coupled thereto via the coupling extension 606 may be stationary. Adjustment (e.g., turning) of the first lead screw 306 and/or the second lead screw 308 may thus adjust a position of the frame 310 and elements coupled thereto (e.g., the CT gantry cover 808), with respect to the sliding block 304 and the arm 806. Alternatively, the CT gantry cover 808 and thus the frame 310 coupled thereto may be stationary. Adjustment of the first lead screw 306 and/or the second lead screw 308 may thus adjust a position of the sliding block 304 and elements coupled thereto (e.g., the arm 806). In this way, the positioning mechanism 302 enables single plane, dual axis movement of the sliding block 304 relative to the frame 310 and single plane, dual axis movement of the frame 310 relative to the sliding block 304.

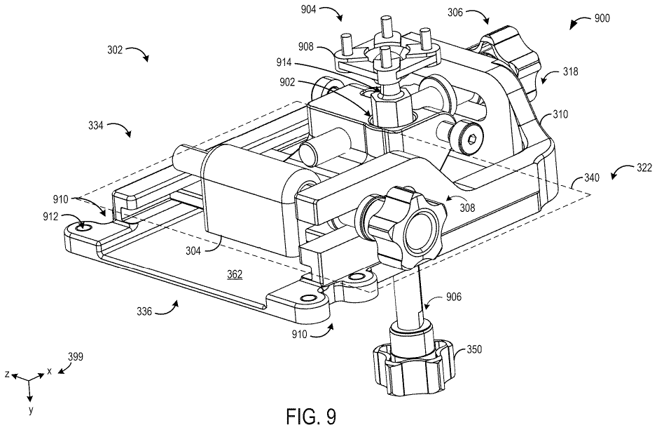

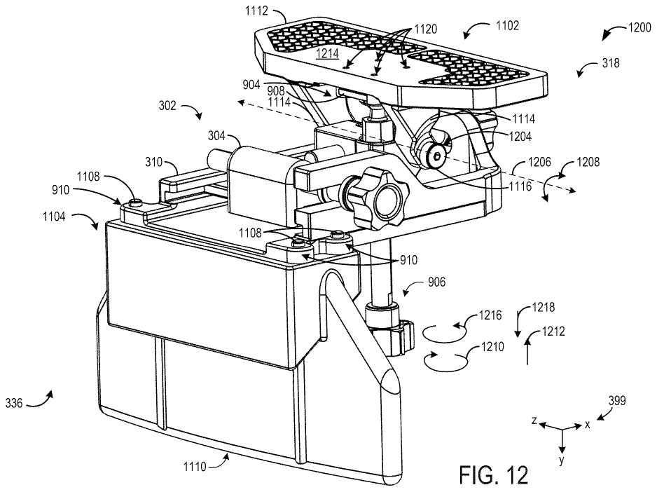

FIG. 9 shows a perspective view 900 of the single plane, dual axis positioning mechanism 302 of FIGS. 3-8. In FIG. 9, the sliding block 304 of the positioning mechanism 302 includes a tilt mechanism receiver 902. A tilt mechanism 904 may be positioned in and/or otherwise fixedly or selectively coupled to the sliding block 304 at the tilt mechanism receiver 902. The tilt mechanism 904 comprises a third lead screw 906 with a knob 350 at a first end and a pivot plate 908 at a second end opposite the first end. The third lead screw 906 is perpendicular to both the first lead screw 306 and the second lead screw 308. The pivot plate 908 may be coupled to the third lead screw 906 via a ball and socket joint 914, where the third lead screw 906 includes a socket and the pivot plate 908 includes a ball that is inserted into the socket. In response to turning the third lead screw 906, the ball may move within the socket to tilt the pivot plate 908 with respect to the single plane in which the sliding block 304 is configured to move. For example, when the pivot plate 908 is in a neutral position, the pivot plate 908 may be parallel to the second plane 340. In response to turning the third lead screw 906, the pivot plate 908 may be tilted into and/or out of the second plane 340, as further described with respect to FIGS. 12, 14, and 15. For example, the tilt mechanism 904 may be operated by third lead screw 906 actuating through ball and socket joint 914 and pivot plate 908.

In the example of FIG. 9, the frame 310 further comprises a set of couplings 910 at the second end 336 of the positioning mechanism 302. The set of couplings 910 includes four extensions that extend from the base 362 of the frame 310 towards the first side 322 and the second side 334 of the positioning mechanism 302. Each of the four extensions includes a through hole 912 aligned with the y-axis. As further described with respect to FIGS. 12, 13, and 16-18, a coupling plate may be coupled to the frame 310 at the set of couplings 910 to couple the positioning mechanism 302 to a system. In other examples, the set of couplings 910 may include more than or less than four extensions, and/or may have different configurations than are shown with respect to FIG. 9.

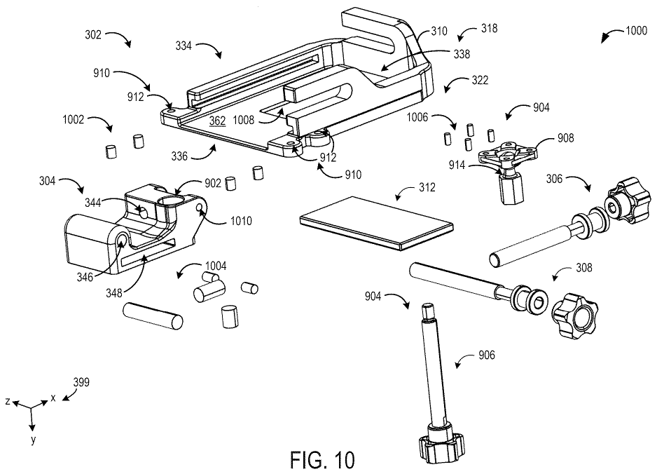

FIG. 10 shows an exploded perspective view 1000 of the positioning mechanism 302 with the tilt mechanism 904, as described with respect to FIG. 9. In some examples, the positioning mechanism 302 includes plugs that are inserted into through holes of the frame 310 and/or the sliding block 304 when one or more elements of the positioning mechanism 302 are excluded from a present assembly thereof. For example, a first set of plugs 1002 may be inserted into the through holes 912 of the set of couplings 910 of the frame 310 when a coupling plate is not coupled to the frame 310. A second set of plugs 1004 may be inserted into the first orifice 344, the second orifice 346, the tilt mechanism receiver 902, and/or hinge receivers 1010 of the sliding block 304. The pivot plate 908 may include a set of pins 1006 that are partially inserted into the pivot plate 908 and may also be partially inserted into a tilt plate to couple the tilt plate to the positioning mechanism 302 via the tilt mechanism 904 (e.g., as further described with respect to FIGS. 12-18).

When the positioning mechanism 302 is configured with the tilt mechanism 904, the frame 310 comprises a third cutout 1008 that extends through the base 362 of the frame 310 to accommodate the third lead screw 906. As described with respect to FIGS. 3 and 5, the sliding block 304 may be moved relative to the frame 310 by adjusting the first lead screw 306 and/or the second lead screw 308. The tilt mechanism 904 extends through the frame 310, as shown in FIG. 9 and further shown in FIGS. 12-18. Thus, the third cutout 1008 of the frame 310 is sized (e.g., has a length parallel to the first side 322 and the second side 334 of the frame 310 and a width parallel to the first end 318 and the second end 336 of the frame 310) such that the sliding block 304 may move throughout the cavity 338 of the frame 310 with the same range of motion when the tilt mechanism 904 is and is not included in the positioning mechanism 302.

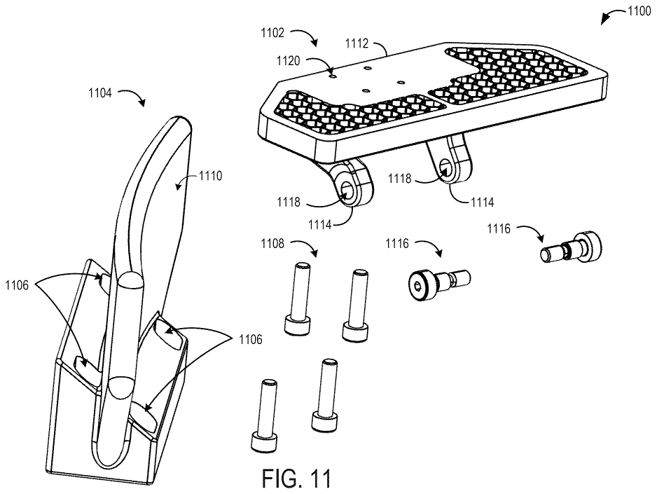

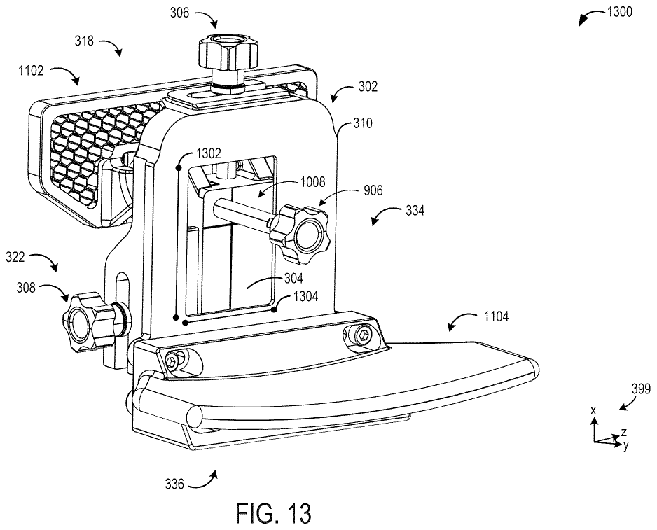

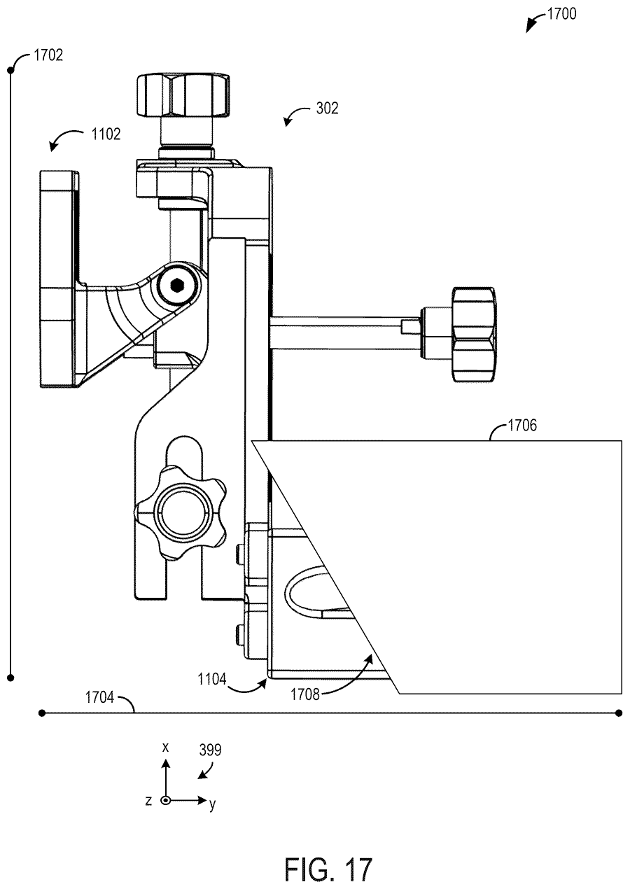

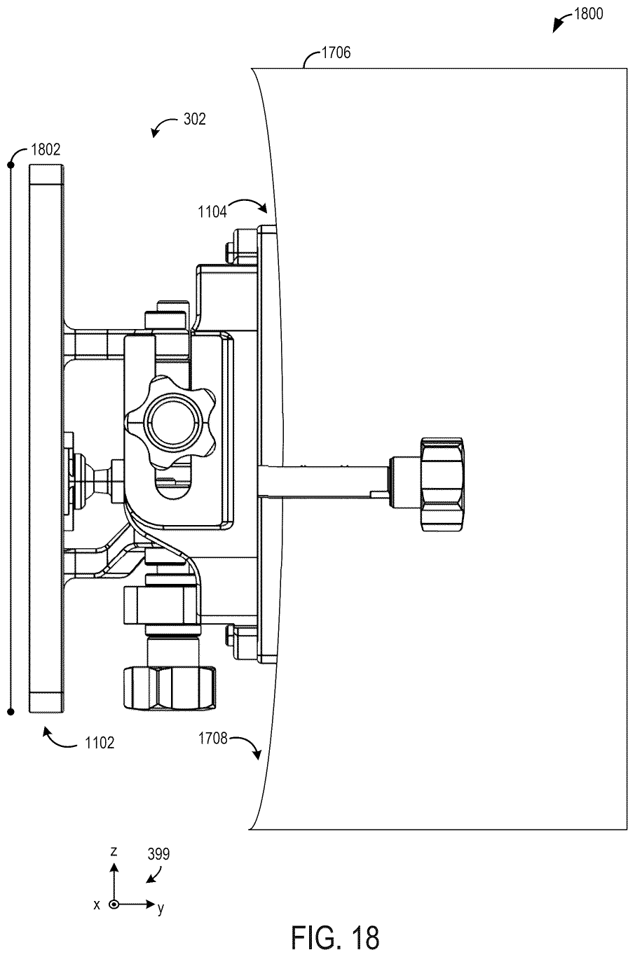

Turning to FIG. 11, perspective views 1100 illustrate example configurations of a tilt plate 1102 and a coupling plate 1104 that may be coupled to the positioning mechanism 302 of FIGS. 3-10. The coupling plate 1104 includes through holes 1106 via which the coupling plate 1104 may be coupled to the frame. For example, a set of fasteners 1108 (e.g., screws, dowels, etc.) may be inserted into through holes 1106 of the coupling plate 1104 and the set of couplings 910 of the frame 310 (e.g., as shown in FIGS. 12-13) to couple the coupling plate 1104 to the frame 310. The coupling plate 1104 may comprise an extension 1110 that is configured to be inserted into a system. In the example coupling plate of FIG. 11, the extension 1110 is a curved extension configured to be inserted into an end of a table of an imaging system, as further described with respect to FIGS. 17 and 18. In other examples, the extension 1110 may have different configurations that correspond to different systems to which it is desirable to couple the positioning mechanism 302. In further examples, the coupling plate 1104 may have a different design that enables the coupling plate 1104 to be coupled to the positioning mechanism 302 via the set of couplings 910 of the frame 310.

The tilt plate 1102 includes a platform 1112 that may be tilted with respect to the positioning mechanism 302 via a hinge mechanism. The hinge mechanism may include extensions 1114 that extend from the platform 1112 at an angle and include through holes 1118. The extensions 1114 may be fixedly coupled to the platform 1112 such that the extensions 1114 and the platform 1112 move (e.g., tilt) as a single piece. The through holes 1118 of the extensions 1114 may be aligned with hinge receivers 1010 of the sliding block 304, as further described with respect to FIG. 12. Hinge pins 1116 may be inserted into the through holes 1118 of the extensions 1114 of the tilt plate 1102, and further inserted into the hinge receivers 1010 of the sliding block 304 to couple the tilt plate to the sliding block 304 via the hinge mechanism. Further, the platform 1112 may include though holes 1120 configured to receive pins 1006 of the pivot plate 908, as further described with respect to FIG. 12.

FIG. 12 shows a perspective view 1200 of the positioning mechanism 302 of FIGS. 3-10 with the tilt plate 1102 and the coupling plate 1104 of FIG. 11 coupled thereto. The set of fasteners 1108 are inserted into the through holes 1106 of the coupling plate 1104 (not visible in FIG. 12) and further extend into the set of couplings 910 of the frame 310 to couple the coupling plate 1104 to the frame 310. The tilt plate 1102 is coupled to the tilt mechanism 904 at the pivot plate 908. Pins 1006 of the pivot plate 908 (e.g., shown in FIG. 10) may be inserted into through holes 1120 of the platform 1112 such that movement (e.g., tilt) of the pivot plate 908 causes tilt of the tilt plate 1102. The tilt plate 1102 is coupled to the sliding block 304 via a hinge mechanism 1204. Hinge pins 1116 may be inserted into and pass through the through holes 1118 (not visible in FIG. 12) of the extensions 1114 of the tilt plate 1102, and further inserted into the hinge receivers 1010 (not visible in FIG. 12) of the sliding block 304.

The hinge mechanism 1204 enables the tilt plate 1102 to tilt about a tilt axis 1206, as shown by an arrow 1208, with respect to the sliding block 304 in response to adjustment of the third lead screw 906. For example, the third lead screw 906 may be turned in a first rotational direction (e.g., counter-clockwise) 1216, which may move the third lead screw 906 in a first linear direction indicated by an arrow 1212, thus tilting the pivot plate 908 and the tilt plate 1102 coupled thereto to a first tilted position (e.g., a face 1214 of the platform 1112 directed away from the second end 336 of the positioning mechanism 302). The tilt plate 1102 may similarly be tilted to a second tilt position, which may be in a direction opposite the tilt of the first tilt position (e.g., the face 1214 of the platform 1112 directed towards the second end 336 of the positioning mechanism 302) by turning the third lead screw 906 in a second rotational direction 1210 (e.g., clockwise), opposite the first rotational direction 1216. Turning the third lead screw 906 in the second rotational direction 1210 may move the third lead screw 906 in a second linear direction indicated by an arrow 1218. In an alternate example, third lead screw 906 may be a reverse thread screw and the actuation of the tilt plate 1102 in response to clockwise and counter-clockwise rotation of third lead screw 906 may be reversed from what is described above. For example, moving the third lead screw 906 in second rotational direction 1210 may move the third lead screw 906 in the first linear direction indicated by arrow 1212 and moving the third lead screw in first rotational direction 1216 may cause movement of third lead screw 906 in the second linear direction indicated by arrow 1218.

FIG. 13 shows a perspective view 1300 of the positioning mechanism 302 of FIGS. 3-10, and 12, with the tilt plate 1102 and the coupling plate 1104 of FIG. 11 coupled thereto. As briefly described with respect to FIGS. 9-10, the frame 310 comprises a third cutout 1008 that extends through the base 362 of the frame 310 to accommodate the third lead screw 906. The third cutout 1008 has a length 1302 parallel to the first side 322 and the second side 334, and a width 1304 parallel to the first end 318 and the second end 336 of the frame 310. The third lead screw 906 of the tilt mechanism 904 extends through the frame 310 perpendicular to both the first lead screw 306 and the second lead screw 308. In this way, the sliding block 304 may move throughout the cavity 338 (not visible in FIG. 13) of the frame 310 with approximately the same range of motion when the tilt mechanism 904 is included as part of and/or is not included as part of the positioning mechanism 302 (e.g., without movement being restricted by the third lead screw 906). Described another way, movement of the sliding block 304 may be prevented from being restricted by the third lead screw 906 whether or not the tilt mechanism 904 is included as part of or is excluded from the positioning mechanism 302.

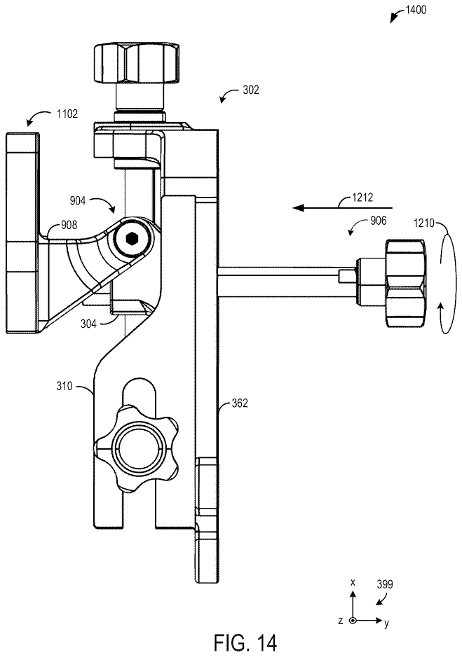

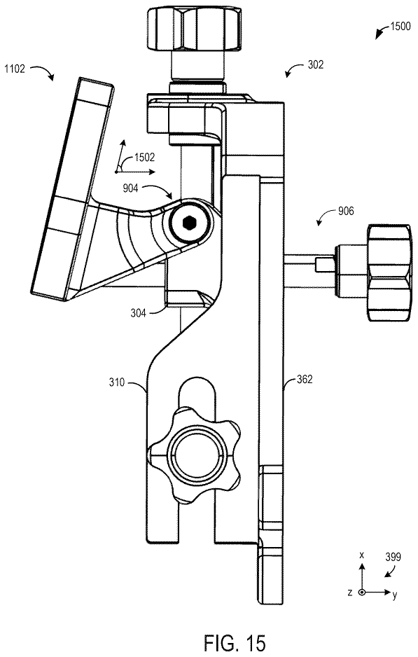

FIG. 14 shows a side view 1400 of the positioning mechanism 302 of FIGS. 3-10 and 12-13 with the tilt plate 1102 coupled thereto. In the configuration shown in FIG. 14, the tilt mechanism 904 is in a neutral position, where the pivot plate 908 and the tilt plate 1102 are parallel to the base 362 of the frame 310 and to the single plane in which the sliding block 304 is moveable. The positioning mechanism 302 may be adjusted from a neutral configuration (e.g., the configuration of FIG. 14) to a first tilted configuration (e.g., as shown in FIG. 15) by turning the third lead screw 906 in the first rotational direction 1216, which moves the third lead screw 906 in the first linear direction shown by arrow 1212, thus tilting the pivot plate 908 and the tilt plate 1102.

FIG. 15 shows a side view 1500 of the positioning mechanism 302 of FIGS. 3-10 and 12-14 with the tilt plate 1102 coupled thereto. In the configuration shown in FIG. 15, the tilt mechanism 904 is in a tilted position (e.g., the first tilted configuration). The pivot plate 908 and the tilt plate 1102 are tilted at an angle 1502 with respect to the base 362 of the frame 310 and to the single plane in which the sliding block 304 is moveable. When the tilt plate 1102 is in the tilted position, the sliding block 304 may be moveable as described herein with respect to FIG. 5.

The tilting ability of the positioning mechanism 302 with the tilt plate 1102 coupled thereto may be used to tilt an element coupled to the tilt plate 1102. For example, the positioning mechanism 302 may be used to hold and position a phantom, such as a phantom for a computed tomography (CT) imaging system. CT phantoms are used to calibrate CT scanners and align components such as an X-ray tube, collimator, detector, and so on. This alignment and calibration process is frequently executed during installation of CT equipment, as well as continuous calibrations by users such as medical technicians, and during component replacements.

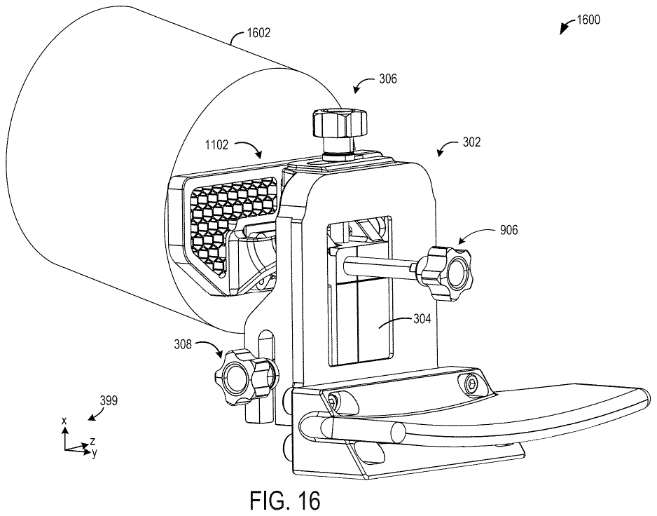

FIG. 16 shows a perspective view 1600 of the positioning mechanism 302 of FIGS. 3-15 with the tilt plate 1102, and further including a phantom 1602 coupled to the tilt plate 1102. The phantom 1602 may be coupled to the tilt plate 1102 via one or more conventional selective coupling methods, such as snap fittings, screws, clamps, fasteners, and so on. The positioning mechanism 302 may be used to hold and position one or more phantoms of different sizes, shapes, weights, formed of different materials, and so on. By coupling the phantom 1602 to the tilt plate 1102 of the positioning mechanism 302, a position of the phantom 1602 may be adjusted within a single plane and along a dual axis by adjusting the sliding block 304 via the first lead screw 306 and/or the second lead screw 308, and further tilted into and out of the single plane by adjusting the tilt plate 1102 via the third lead screw 906. For example, the positioning mechanism 302 may adjust a position of the phantom 1602 within a scan plane for calibration and adjustment of an imaging system (e.g., the imaging system 100 of FIGS. 1-2), such that the phantom 1602 is inside a scan field of view.

FIG. 17 shows a side view 1700 of the positioning mechanism 302 of FIGS. 3-16 with the coupling plate 1104 and the tilt plate 1102 coupled thereto. The positioning mechanism 302 has a height 1702 parallel to the first side 322 and the second side 334 (e.g., parallel to the x-axis), and a length 1704 perpendicular to the first side 322 and the second side 334 (e.g., parallel to the y-axis). In the configuration shown in FIG. 17 (e.g., the neutral configuration, also shown in FIG. 14), the length 1704 is equal to the height 1702. For example, the length 1704 and the height 1702 may each be 158 millimeters (mm).

The coupling plate 1104 is further coupled to a table 1706. The table 1706 may be an example of a table of an imaging system, such as the table 114 of the imaging system 100 of FIGS. 1-2. The table 1706 may include a receiving slot at a first end 1708. The extension 1110 of the coupling plate 1104 may be complimentary to the receiving slot of the table 1706 and may be inserted into the receiving slot to couple the positioning mechanism 302 to the table 1706. For example, the receiving slot may be curved, and a curvature of the extension 1110 of the coupling plate 1104 may be complementary to the curve of the receiving slot, as further shown in FIG. 18.

FIG. 18 shows a top-down view 1800 of the positioning mechanism 302 of FIGS. 3-17 with the coupling plate 1104 and the tilt plate 1102 coupled thereto. FIG. 18 shows the positioning mechanism 302 in the same configuration as is shown in FIG. 17, where the positioning mechanism 302 is coupled to the table 1706 via the coupling plate 1104. The positioning mechanism 302 has a width 1802 that is parallel to the first end 318 and the second end 336 (e.g., parallel to the z-axis). The width 1802 may be greater than the height 1702 and the length 1704 of the positioning mechanism 302. For example, the width 1802 may be 177 mm.

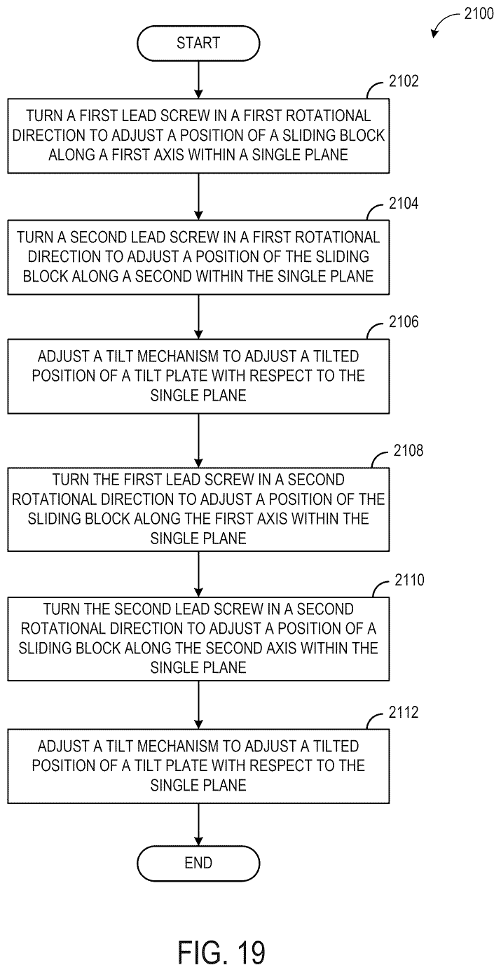

FIG. 19 is a flowchart for a method 2100 for a single plane dual axis positioning mechanism. The method 2100 may be implemented by a control device coupled to a rotational power source configured to turn one or more of a first lead screw, a second lead screw, and a third lead screw of the positioning mechanism. For example, the method 2100 may be implemented by the computing device 216 configured to control the rotational power source 226 coupled to the positioning mechanism 228 of FIG. 2. In a further example, the method 2100 may be implemented by the joint control system 522 configured to control to one or more rotational power source 520 coupled to the positioning mechanism 302 of FIG. 5. Instructions for executing the method 2100 may be stored in a memory of the controller (e.g., the computing device 216, the joint control system 522) and executed by a processor of the controller.

The method 2100 comprises providing power by a rotational power source to move a sliding block within a single plane in a first horizontal and/or vertical direction for a first configuration. In the first configuration, a first lead screw and/or a second lead screw are configured to receive power from the rotational power source to turn the first lead screw in a first rotational direction and turn the second lead screw in the first rotational direction. The method 2100 further comprises providing power by the rotational power source to move the sliding block within the single plane in a second horizontal and/or vertical direction for a second configuration, different from the first horizontal and/or vertical direction. In the second configuration, the first lead screw and/or the second lead screw are configured to receive power from the rotational power source to turn one or more of the first lead screw and the second lead screw in a second rotational direction, different from the first rotational direction. In some examples, the positioning mechanism further includes a tilt plate and a tilt mechanism, where the tilt mechanism may be adjusted to adjust a tilt position of the tilt plate with respect to the single plane. In this example, the method 2100 further includes providing power, by the rotational power source, in a third configuration of the drive system to move a tilt plate coupled to the sliding block via a hinged mechanism and via a tilt mechanism into and out of the single plane, wherein the third configuration comprises administering power to a third lead screw of the tilt mechanism from the rotational power source to turn the third lead screw in the first rotational direction.

At 2102, the method 2100 includes turning a first lead screw in a first rotational direction to adjust a position of a sliding block along a first axis within a single plane. The first lead screw may be turned by the rotational power source (e.g., via power administered by the rotational power source to the first lead screw). The first rotational direction may be a clockwise direction. Turning the first lead screw in the first rotational direction may move the sliding block in a first linear direction along the first axis. The first axis may be a translational axis (e.g., an X-axis). A frame of the positioning mechanism may be fixed to a system such that the frame is stationary and the sliding block moves with respect to the frame in response to turning the first lead screw and/or the second lead screw in a clockwise and/or counter-clockwise direction.

At 2104, the method 2100 includes turning a second lead screw in the first rotational direction to adjust a position of the sliding block along a second axis within the single plane. The second lead screw may be turned by the rotational power source (e.g., via power administered by the rotational power source to the second lead screw). The first rotational direction may be a clockwise direction. Turning the second lead screw in the first rotational direction may move the sliding block in a first linear direction along the second axis. The second axis may be a lateral axis (e.g., a Y-axis) that is perpendicular to the first axis.

At 2106, the method 2100 includes adjusting a tilt mechanism to adjust a tilted position of a tilt plate with respect to the single plane. For example, adjusting the tilt mechanism may include turning a third lead screw of the tilt mechanism in the first rotational direction. The tilt mechanism may include a ball and socket joint where, in response to turning the third lead screw, a ball may move within a socket to tilt the tilt plate with respect to the single plane in which the sliding block is configured to move. In response to adjusting the tilt mechanism, the tilt plate may be tilted into and/or out of the single plane.

At 2108, the method 2100 includes turning the first lead screw in a second rotational direction to adjust a position of a sliding block along the first axis within the single plane. The first lead screw may be turned by the rotational power source (e.g., via power administered by the rotational power source to the first lead screw). The second rotational direction may be opposite the first rotational direction (e.g., a counter-clockwise direction). Turning the first lead screw in the second rotational direction may move the sliding block in a second linear direction along the first axis, opposite the first linear direction.

At 2110, the method 2100 includes turning the second lead screw in the second rotational direction to adjust a position of the sliding block along the second axis within the single plane. The second lead screw may be turned by the rotational power source (e.g., via power administered by the rotational power source to the second lead screw). Turning the second lead screw in the second rotational direction may move the sliding block in a second linear direction along the second axis.

At 2112, the method 2100 includes adjusting the tilt mechanism to adjust a tilted position of a tilt plate with respect to the single plane. For example, adjusting the tilt mechanism may include turning the third lead screw of the tilt mechanism in the second rotational direction to adjust the tilt plate into and/or out of the single plane.

One or more of the operations of the method 2100 may be performed at the same time. For example, the first lead screw and the second lead screw may be turned at the same time in the same direction (e.g., the first rotational direction) and/or in different directions. Additionally or alternatively, one or more of the operations of the method 2100 may be performed in an order different than the order described with respect to FIG. 19. For example, the second lead screw may be turned to adjust the position of the sliding block along the second axis before the first lead screw is turned to adjust the position of the sliding block along the first axis.

The positioning mechanism is thus configured to achieve two independent motions (e.g., lateral-translational or horizontal-vertical) through a single plane frame and two-way slider design. Dual axis movement is integrated in the single plane frame using a rotational sliding joint design. Turning the first lead screw (e.g., clockwise or counter-clockwise) moves the sliding block along the first axis and further causes the second lead screw to slide and hold a position of the sliding block along the second axis, perpendicular to the first axis. Turning the second lead screw moves the sliding block along the second axis and further causes the first lead screw to slide and hold the position of the sliding block along the first axis. Both lateral axis and translational axis movements are thus achieved in the single sliding block in a single plane, thus the positioning mechanism eliminates demand for two linear sliders and/or multiple blocks to achieve the dual axis movement.

The positioning mechanism described herein is smaller and more compact than conventional designs. The positioning mechanism described herein provides a reduction in number of parts, compared to the conventional design. The positioning mechanism includes two screws attached to a single body that enables planar motion in two directions. The positioning mechanism provides on-gantry alignment without issues with uniform movement, less components, ease of assembly/operation, compact and light weight design, and horizontal movement achieves with adjustment from one side. The positioning mechanism may include >60% less parts than conventional systems. Overall dimensions of the positioning mechanism may be >65% smaller than conventional designs (e.g., 177 mm×158 mm×158 mm). An assembly weight of the positioning mechanism may be >75% less than conventional designs (e.g., 1 kilogram (kg) vs 5 kg). A calibration and/or imaging demand of an imaging system that uses the positioning mechanism to support a phantom, gantry cover, or other element may be decreased in complexity, time, and part cost, as less parts are used to hold and position the phantom, compared to conventional holders. A weight of the positioning mechanism may be less than conventional designs, which makes the positioning mechanism more ergonomic. For example, the positioning mechanism weight may be >75% less than conventional designs (e.g., 0.4 kg).

The positioning holder may be implemented in CT, PET/CT, and/or NM/CT systems. The positioning holder may be formed at least in part by metal additive manufacturing, which enables the components to be formed with reduced material and lesser weight, compared to conventional designs. This also provides flexibility and freedom in designing while also making the device easier, safer, and faster to handle. In alternate examples, the positioning holder may be formed at least in part by conventional manufacturing.

The disclosure also provides support for a positioning mechanism, comprising: a first lead screw, a second lead screw, a guide plate, a sliding block comprising a first orifice to receive the first lead screw, a second orifice to receive the second lead screw, and a third orifice to receive the guide plate, and a frame comprising a first cutout configured to receive the first lead screw, a second cutout configured to receive the second lead screw, and a first slot and a second slot configured to receive the guide plate, where the sliding block is movable within a single plane along a first axis and/or along a second axis that is perpendicular to the first axis in response to turning the first lead screw and/or the second lead screw and as guided by the guide plate. In a first example of the system, the frame is fixed to a system such that the frame is stationary and the sliding block moves with respect to the frame in response to turning the first lead screw and/or the second lead screw. In a second example of the system, optionally including the first example, the first lead screw is perpendicular to the second lead screw. In a third example of the system, optionally including one or both of the first and second examples, the system further comprises: a coupling extension that extends from the sliding block perpendicular to the single plane in which the sliding block is moveable. In a fourth example of the system, optionally including one or more or each of the first through third examples, the frame comprises a set of couplings at a second end, opposite a first end at which the first lead screw is inserted into the first cutout of the frame, wherein the set of couplings is configured to couple the positioning mechanism to the system. In a fifth example of the system, optionally including one or more or each of the first through fourth examples, the system further comprises: a coupling plate coupled to the frame via the set of couplings. In a sixth example of the system, optionally including one or more or each of the first through fifth examples, the sliding block includes a tilt mechanism receiver. In a seventh example of the system, optionally including one or more or each of the first through sixth examples, the system further comprises: a tilt mechanism positioned in the tilt mechanism receiver, where the tilt mechanism comprises a third lead screw coupled to a pivot plate via a ball and socket joint, where a ball moves within a socket of the ball and socket joint in response to turning the third lead screw to tilt the pivot plate with respect to the single plane. In an eighth example of the system, optionally including one or more or each of the first through seventh examples, the system further comprises: a tilt plate coupled to the tilt mechanism at the pivot plate. In a ninth example of the system, optionally including one or more or each of the first through eighth examples, the tilt plate is coupled to the sliding block via a hinge mechanism. In a tenth example of the system, optionally including one or more or each of the first through ninth examples, the third lead screw is perpendicular to the first lead screw and the second lead screw. In an eleventh example of the system, optionally including one or more or each of the first through tenth examples, each of the first lead screw and the second lead screw have a knob at a first end, where a knob diameter of the knob is greater than a screw diameter of a body of each of the first lead screw and the second lead screw. In a twelfth example of the system, optionally including one or more or each of the first through eleventh examples, the system further comprises: polymer-based bush bearings and liners positioned between one or more of the first orifice of the sliding block and the first lead screw, the second orifice of the sliding block and the second lead screw, the third orifice of the sliding block and the guide plate, the first cutout of the frame and the first lead screw, the second cutout of the frame and the second lead screw, and the first slot and the second slot of the frame and the guide plate.

The disclosure also provides support for a positioning mechanism, comprising: a single-plane slider frame having a first cutout at a first end, a second cutout on a first side that is perpendicular to the first end, a first slot on the first side, and a second slot on a second side that is parallel to the first side, where the first cutout and the second cutout are in a first plane, and the first slot and the second slot are in a second plane that is vertically below the first plane, a first lead screw positioned in the first cutout and extending towards a second end, opposite the first end, in the first plane, a second lead screw positioned in the second cutout and extending towards the second side in the first plane, a sliding block positioned in a cavity of the single-plane slider frame between the first side, the second side, the first end, and the second end, the sliding block having a first orifice parallel to the first cutout and configured to receive the first lead screw, a second orifice parallel to the second cutout and configured to receive the second lead screw, and a third orifice parallel to the first slot and the second slot, and a two-way guide plate positioned in the third orifice of the sliding block and extending outside of the third orifice of the sliding block on the first side and the second side and into the first slot and the second slot of the single-plane slider frame. In a first example of the system, the single-plane slider frame is fixed to a system such that the single-plane slider frame is stationary and the sliding block moves with respect to the single-plane slider frame in response to turning the first lead screw and/or the second lead screw. In a second example of the system, optionally including the first example, one or more of the two-way guide plate, the sliding block, and the single-plane slider frame are formed via additive manufacturing, wherein additive manufacturing includes one or more of metal based 3D printing and polymer based 3D printing. In a third example of the system, optionally including one or both of the first and second examples, one or more of the two-way guide plate, the sliding block, and the single-plane slider frame are formed via conventional manufacturing. In a fourth example of the system, optionally including one or more or each of the first through third examples, the system further comprises: a tilt plate coupled to the sliding block via a hinged mechanism and via a tilt mechanism positioned in a tilt mechanism receiver of the sliding block, the tilt mechanism receiver perpendicular to the first cutout and the second cutout of the single-plane slider frame, and the tilt mechanism including a third lead screw perpendicular to first plane and the second plane, and further comprising a coupling extension that extends from the sliding block perpendicular to the first plane and the second plane.

The disclosure also provides support for a method for a single plane dual axis positioning mechanism, comprising: providing power by a rotational power source to move a sliding block within a single plane in a first horizontal and/or vertical direction for a first configuration, wherein the first configuration comprises administering power to a first lead screw and/or a second lead screw from the rotational power source to turn the first lead screw in a first rotational direction and turn the second lead screw in the first rotational direction, and providing power by the rotational power source to move the sliding block within the single plane in a second horizontal and/or vertical direction for a second configuration, different from the first horizontal and/or vertical direction, wherein the second configuration comprises administering power to the first lead screw and/or the second lead screw from the rotational power source to turn one or more of the first lead screw and the second lead screw in a second rotational direction, different from the first rotational direction. In a first example of the method, the method further comprises: providing power, by the rotational power source, in a third configuration to move a tilt plate coupled to the sliding block via a hinged mechanism and via a tilt mechanism into and out of the single plane, wherein the third configuration comprises administering power to a third lead screw of the tilt mechanism from the rotational power source to turn the third lead screw in the first rotational direction.

FIGS. 1-18 show example configurations with relative positioning of the various components. FIGS. 3-18 are drawn to scale, although other relative dimensions may be used, if desired. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

As used herein, an element or step recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A positioning mechanism, comprising:
a first lead screw;
a second lead screw;
a guide plate;
a sliding block comprising a first orifice to receive the first lead screw, a second orifice to receive the second lead screw, and a third orifice to receive the guide plate; and
a frame comprising a first cutout configured to receive the first lead screw, a second cutout configured to receive the second lead screw, and a first slot and a second slot configured to receive the guide plate, where the sliding block is movable within a single plane along at least one of a first axis and a second axis that is perpendicular to the first axis in response to at least one of turning the first lead screw and the second lead screw and as guided by the guide plate.

2. The positioning mechanism of claim 1, wherein the frame is fixed to a system such that the frame is stationary and the sliding block moves with respect to the frame in response to turning the first lead screw and the second lead screw.

3. The positioning mechanism of claim 1, wherein the first lead screw is perpendicular to the second lead screw.

4. The positioning mechanism of claim 1, further comprising a coupling extension that extends from the sliding block perpendicular to the single plane in which the sliding block is moveable.

5. The positioning mechanism of claim 2, wherein the frame comprises a set of couplings at a second end, opposite a first end at which the first lead screw is inserted into the first cutout of the frame, wherein the set of couplings is configured to couple the positioning mechanism to the system.

6. The positioning mechanism of claim 5, further comprising a coupling plate coupled to the frame via the set of couplings.

7. The positioning mechanism of claim 1, wherein the sliding block includes a tilt mechanism receiver.

8. The positioning mechanism of claim 7, further comprising a tilt mechanism positioned in the tilt mechanism receiver, where the tilt mechanism comprises a third lead screw coupled to a pivot plate via a ball and socket joint, where a ball moves within a socket of the ball and socket joint in response to turning the third lead screw to tilt the pivot plate with respect to the single plane.

9. The positioning mechanism of claim 8, further comprising a tilt plate coupled to the tilt mechanism at the pivot plate.

10. The positioning mechanism of claim 9, wherein the tilt plate is coupled to the sliding block via a hinge mechanism.

11. The positioning mechanism of claim 8, wherein the third lead screw is perpendicular to the first lead screw and the second lead screw.

12. The positioning mechanism of claim 1, wherein each of the first lead screw and the second lead screw have a knob at a first end, where a knob diameter of the knob is greater than a screw diameter of a body of each of the first lead screw and the second lead screw.

13. The positioning mechanism of claim 1, further comprising polymer-based bush bearings and liners positioned between one or more of the first orifice of the sliding block and the first lead screw, the second orifice of the sliding block and the second lead screw, the third orifice of the sliding block and the guide plate, the first cutout of the frame and the first lead screw, the second cutout of the frame and the second lead screw, and the first slot and the second slot of the frame and the guide plate.

14. A positioning mechanism, comprising:
a single-plane slider frame having:
a first cutout at a first end;
a second cutout on a first side that is perpendicular to the first end;
a first slot on the first side; and
a second slot on a second side that is parallel to the first side, where the first cutout and the second cutout are in a first plane, and the first slot and the second slot are in a second plane that is vertically below the first plane;
a first lead screw positioned in the first cutout and extending towards a second end, opposite the first end, in the first plane;
a second lead screw positioned in the second cutout and extending towards the second side in the first plane;
a sliding block positioned in a cavity of the single-plane slider frame between the first side, the second side, the first end, and the second end, the sliding block having:
a first orifice parallel to the first cutout and configured to receive the first lead screw;
a second orifice parallel to the second cutout and configured to receive the second lead screw; and
a third orifice parallel to the first slot and the second slot; and
a two-way guide plate positioned in the third orifice of the sliding block and extending outside of the third orifice of the sliding block on the first side and the second side and into the first slot and the second slot of the single-plane slider frame.

15. The positioning mechanism of claim 14, wherein the single-plane slider frame is fixed to a system such that the single-plane slider frame is stationary and the sliding block moves with respect to the single-plane slider frame in response to turning the first lead screw and/or the second lead screw.

16. The positioning mechanism of claim 14, wherein one or more of the two-way guide plate, the sliding block, and the single-plane slider frame are formed via additive manufacturing, wherein additive manufacturing includes one or more of metal based 3D printing and polymer based 3D printing.

17. The positioning mechanism of claim 14, wherein one or more of the two-way guide plate, the sliding block, and the single-plane slider frame are formed via conventional manufacturing.

18. The positioning mechanism of claim 14, further comprising a tilt plate coupled to the sliding block via a hinged mechanism and via a tilt mechanism positioned in a tilt mechanism receiver of the sliding block, the tilt mechanism receiver perpendicular to the first cutout and the second cutout of the single-plane slider frame, and the tilt mechanism including a third lead screw perpendicular to first plane and the second plane, and further comprising a coupling extension that extends from the sliding block perpendicular to the first plane and the second plane.

19. A method for a single plane dual axis positioning mechanism, comprising:
providing power by a rotational power source to move a sliding block within a single plane in a first horizontal and/or vertical direction for a first configuration, wherein the first configuration comprises administering power to a first lead screw and/or a second lead screw from the rotational power source to turn the first lead screw in a first rotational direction and turn the second lead screw in the first rotational direction; and
providing power by the rotational power source to move the sliding block within the single plane in a second horizontal and/or vertical direction for a second configuration, different from the first horizontal and/or vertical direction, wherein the second configuration comprises administering power to the first lead screw and/or the second lead screw from the rotational power source to turn one or more of the first lead screw and the second lead screw in a second rotational direction, different from the first rotational direction.

20. The method of claim 19, further comprising:
providing power, by the rotational power source, in a third configuration to move a tilt plate coupled to the sliding block via a hinged mechanism and via a tilt mechanism into and out of the single plane, wherein the third configuration comprises administering power to a third lead screw of the tilt mechanism from the rotational power source to turn the third lead screw in the first rotational direction.
